(19) United States
(12) Patent Application Publication
(10) Pub. No.: US 2026/0341991 A1
(43) Pub. Date: Oct. 29, 2026

(54) CONNECTOR AND HOUSING UNIT

(71) Applicant: YAZAKI CORPORATION, Tokyo (JP)

(72) Inventors: Mitsuhisa Sano, Susono-shi (JP); Kenichi Katsumata, Susono-shi (JP); Masato Ando, Makinohara-shi (JP); Naomi Kisu, Susono-shi (JP)

(21) Appl. No.: 19/645,866

(22) Filed: Apr. 13, 2026

(30) Foreign Application Priority Data
Apr. 28, 2025 (JP) 2025-074790

(51) Int. Cl. H01R 12/77

(52) U.S. Cl. CPC H01R 12/778; H01R 2201/26

(57) ABSTRACT

A connector includes a housing, a terminal that is accommodated in the housing, and a flat electric wire electrically connected to the terminal. The flat electric wire includes a conductor, and an insulating layer sandwiching the conductor. The terminal includes a wall-shaped portion defining a space in which the conductor of the flat electric wire is disposed and facing an inner surface of an accommodating portion of the housing, a contact portion provided on an inner surface of the wall-shaped portion and coming into pressure contact with the conductor, and an engaging portion engaging with the insulating layer.

### CROSS-REFERENCE TO RELATED APPLICATIONS

This application is based on and claims priority under 35 USC 119 from Japanese Patent Application No. 2025-074790 filed on Apr. 28, 2025, the contents of which are incorporated herein by reference.

### TECHNICAL FIELD

The present disclosure relates to a connector including a housing, a terminal configured to be accommodated in the housing, and a flat electric wire configured to be electrically connected to the terminal, and a housing unit used for the connector.

### BACKGROUND ART

In the related art, a circuit body (so-called wire harness) for connecting a power supply mounted on a vehicle or the like, an electric junction box, various electrical components, and the like has been known (for example, see Patent Literature 1).

### CITATION LIST

### PATENT LITERATURE

Patent Literature 1: JP2005-078962A

### SUMMARY OF INVENTION

The type of circuit body described above generally includes a plurality of electric wires, terminals attached to respective end portions of the plurality of electric wires, and a housing that accommodates the terminals. Since this type of circuit body generally has a structure in which a plurality of electric wires are bundled together and integrated by wrapping a tape or the like around them, the diameter tends to increase as the number of circuits increases, and it is difficult to reduce the thickness. In contrast, it is conceivable to implement a circuit body using a flat electric wire (for example, a flat flexible cable) that can be made thinner than an electric wire bundle. Even in the case of using the flat electric wire, it is desired to improve the reliability of the electrical connection between the flat electric wire and the terminal as in the case of using the related electric wire bundle.

An object of the present disclosure is to provide a connector and a housing unit excellent in reliability of electrical connection between a flat electric wire and a terminal.

In order to achieve the object described above, a connector and a housing unit according to the present disclosure is characterized as follows.

A connector of the present disclosure includes a housing, a terminal that is accommodated in the housing, and a flat electric wire electrically connected to the terminal. The flat electric wire includes a conductor, and an insulating layer sandwiching the conductor. The terminal includes a wall-shaped portion defining a space in which the conductor of the flat electric wire is disposed and facing an inner surface of an accommodating portion of the housing, a contact portion provided on an inner surface of the wall-shaped portion and coming into pressure contact with the conductor, and an engaging portion engaging with the insulating layer.

A housing unit of the present disclosure is attached to an end portion of a flat electric wire. The housing unit includes a housing and a terminal that is accommodated in the housing. The terminal includes a wall-shaped portion defining a space in which a conductor of the flat electric wire is disposed and facing an inner surface of an accommodating portion of the housing, a contact portion provided on an inner surface of the wall-shaped portion and coming into pressure contact with the conductor, and an engaging portion engaging with an insulating layer of the flat electric wire.

According to the connector and the housing unit of the present disclosure, the terminal includes the wall-shaped portion facing the inner surface of the accommodating portion of the housing, the contact portion provided on the inner surface of the wall-shaped portion and configured to come into pressure contact with the conductor, and the engaging portion configured to engage with the insulating layer. Accordingly, as compared with a case in which the contact portion is simply provided in the terminal, the displacement of the flat electric wire (for example, displacement such that the flat electric wire is unintentionally separated from the housing) is restricted by the action of the engaging portion. Therefore, the connector and the housing unit according to the present disclosure are excellent in reliability of electrical connection between the flat electric wire and the terminal.

The present disclosure is briefly described above. Further, details of the present disclosure will be further clarified by reading modes for carrying out the invention described below with reference to the accompanying drawings.

### BRIEF DESCRIPTION OF DRAWINGS

FIG. 1 is a perspective view illustrating a connector according to a first embodiment of the present disclosure;

FIG. 2 is a perspective view illustrating an end portion of a flat electric wire illustrated in FIG. 1;

FIG. 3 is a cross-sectional view corresponding to a cross section A-A in FIG. 1 in a state in which the terminal is accommodated in a housing;

FIG. 4 is a cross-sectional view corresponding to FIG. 3 in a state in which assembly of the connector is completed by inserting the end portion of the flat electric wire into a space between a pair of wall-shaped portions of the terminal from the state illustrated in FIG. 3;

FIG. 5 is an enlarged view of a portion B in FIG. 4;

FIG. 6 is a cross-sectional view corresponding to FIG. 3 in a connector according to a second embodiment of the present disclosure;

FIG. 7 is a cross-sectional view corresponding to FIG. 6 in a state in which an end portion of a flat electric wire is inserted into a space between a pair of wall-shaped portions of a terminal from the state illustrated in FIG. 6;

FIG. 8 is a cross-sectional view corresponding to FIG. 6 in a state in which assembly of the connector is completed by assembling a pressing member to a housing from the state illustrated in FIG. 7; and

FIG. 9 is an enlarged view corresponding to FIG. 5 in the connector illustrated in FIG. 8.

### DESCRIPTION OF EMBODIMENTS

### First Embodiment

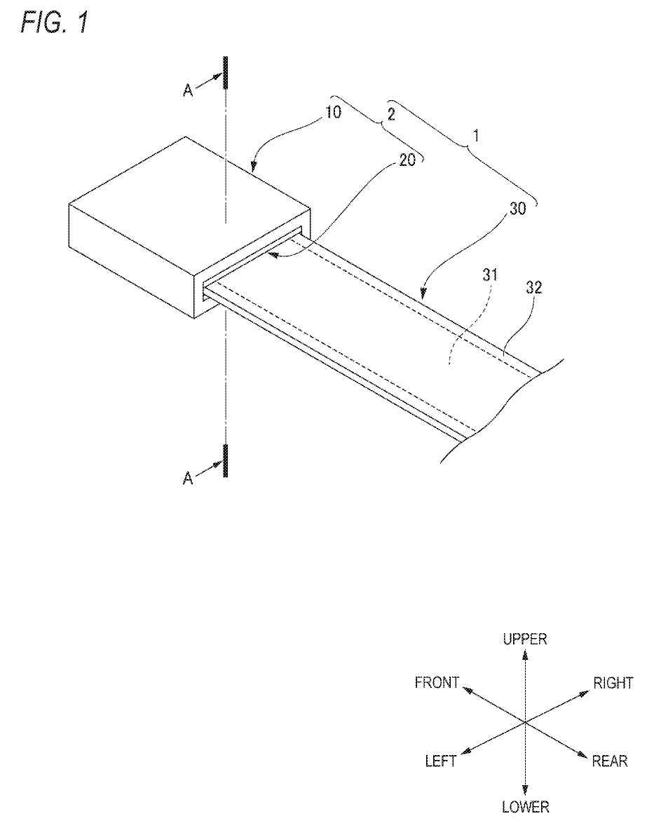

Hereinafter, a connector 1 according to a first embodiment of the present disclosure will be described with reference to FIGS. 1 - 5. As illustrated in FIG. 1 and the like, the connector 1 according to the first embodiment includes a housing 10, a terminal 20 accommodated in the housing 10, and a flat electric wire 30 electrically connected to the terminal 20. The housing 10 and the terminal 20 constituting the connector 1 constitute a housing unit 2 according to the present disclosure (see FIG. 1). The connector 1 is mounted on a vehicle and used, for example, in a state of being fitted with a counterpart connector (not illustrated).

Hereinafter, for convenience of description, "front", "rear", "left", "right", "upper", and "lower" are defined as illustrated in FIG. 1 or the like. A "front-rear direction", a "left-right direction", and an "upper-lower direction" are orthogonal to one another. The front-rear direction coincides with a fitting direction of the connector 1 and the counterpart connector and also coincides with an extending direction of the flat electric wire 30. The front-rear direction, the left-right direction, and the upper-lower direction do not necessarily coincide with a front-rear direction, a left-right direction, and an upper-lower direction of a vehicle when the connector 1 is mounted on the vehicle. Hereinafter, a configuration of each member implementing the connector 1 will be described in order.

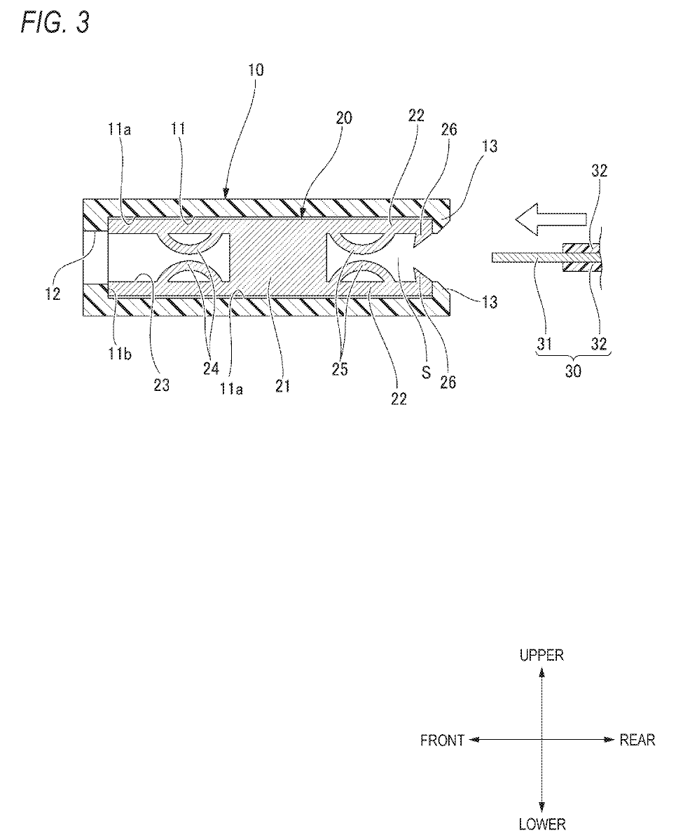

First, the housing 10 will be described. The housing 10 is a resin molded body, and as illustrated in FIGS. 1 and 3, has a substantially rectangular box shape that is flat and short in the upper-lower direction and extends in the front-rear direction. Inside the housing 10 is defined a substantially rectangular parallelepiped hollow portion that is flat and short in the upper-lower direction, extends in the front-rear direction, and opens rearward. As illustrated in FIG. 3, the hollow portion functions as an accommodating portion 11 that accommodates the terminal 20.

As illustrated in FIG. 3, a front wall of the housing 10 is provided with a communicating hole 12 that communicates the outside of the housing 10 with the accommodating portion 11. When the connector 1 and the counterpart connector are fitted to each other, a counterpart terminal (not illustrated) belonging to the counterpart connector is inserted into the accommodating portion 11 of the housing 10 via the communicating hole 12 and electrically connected to the terminal 20 accommodated in the accommodating portion 11.

As illustrated in FIG. 3, each of rear end portions of a pair of upper and lower inner surfaces 11a (inner surfaces of an upper wall and a lower wall of the housing 10) defining the accommodating portion 11 of the housing 10 is provided with a protrusion 13 protruding toward the terminal 20 accommodated in the accommodating portion 11 (inward in the upper-lower direction). An effect of providing such protrusions 13 will be described later.

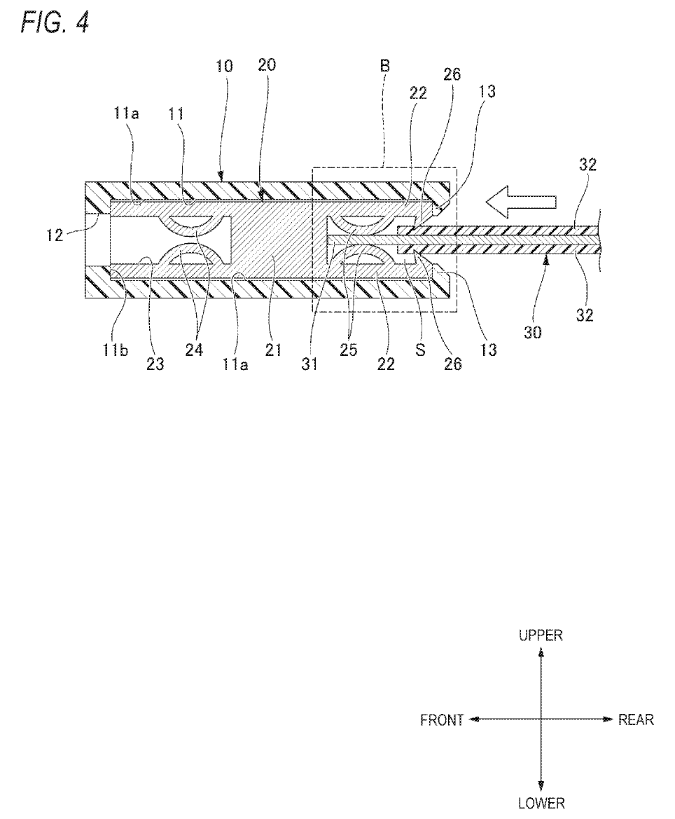

Next, the terminal 20 will be described. As illustrated in FIG. 3, the metal terminal 20 includes a main body portion 21 having a substantially rectangular parallelepiped shape that is flat and short in the upper-lower direction and extends in the front-rear direction, and a pair of upper and lower substantially rectangular flat plate-shaped wall-shaped portions 22 each extending rearward from upper and lower end edge portions of a rear end surface of the main body portion 21, and has an overall shape that can be accommodated in the accommodating portion 11 of the housing 10. The pair of upper and lower wall-shaped portions 22 are disposed to face each other at an interval in the upper-lower direction. Each of the pair of upper and lower wall-shaped portions 22 is elastically deformable so as to be displaced in the upper-lower direction. An end portion of the flat electric wire 30 is to be inserted and disposed in a space S defined by the pair of upper and lower wall-shaped portions 22 (see FIG. 4 and the like).

As illustrated in FIG. 3, a recess 23 recessed rearward is provided on a front end surface of the main body portion 21 of the terminal 20. When the connector 1 and the counterpart connector are fitted to each other, the counterpart terminal inserted into the accommodating portion 11 of the housing 10 through the communicating hole 12 is inserted into the recess 23. A contact portion 24 is provided on each of a pair of upper and lower inner surfaces defining the recess 23. In the example illustrated in FIG. 3, each of the pair of upper and lower contact portions 24 has a double-supported beam shape that protrudes toward the counterpart terminal inserted into the recess 23 (inward in the upper-lower direction) and extends in the front-rear direction. The counterpart terminal inserted into the recess 23 is electrically connected to the terminal 20 by being pressed and sandwiched by the pair of upper and lower contact portions 24.

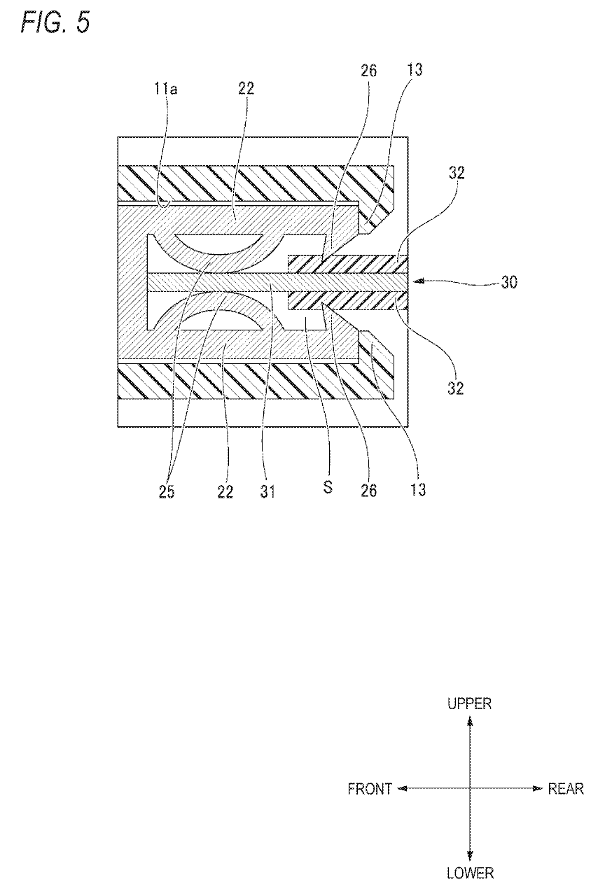

As illustrated in FIG. 3, a contact portion 25 is provided on each of inner surfaces (surfaces facing each other) of the pair of upper and lower wall-shaped portions 22 of the terminal 20. In the example illustrated in FIG. 3, each of the pair of upper and lower contact portions 25 has a double-supported beam shape that protrudes toward the end portion of the flat electric wire 30 inserted into the space S between the pair of upper and lower wall-shaped portions 22 (inward in the upper-lower direction) and extends in the front-rear direction. In the non-elastically deformed state of the pair of upper and lower contact portions 25, the interval between top ends of the pair of upper and lower contact portions 25 is smaller than a thickness (length in the upper-lower direction) of a conductor layer 31 of the flat electric wire 30 described later. Further, each of extending end portions (rear end portions) of the pair of upper and lower wall-shaped portions 22 of the terminal 20 is provided with an engaging protrusion 26 protruding toward the end portion of the flat electric wire 30 inserted into the space S between the pair of upper and lower wall-shaped portions 22 (inward in the upper-lower direction). A tip portion of the engaging protrusion 26 has a sharp shape with a sharp tip so as to be able to bite into an insulating layer 32 described later of the flat electric wire 30 (see FIG. 5 and the like). In the non-elastically deformed state of the pair of upper and lower wall-shaped portions 22, the interval between the tips of the pair of upper and lower engaging protrusions 26 is smaller than a thickness (length in the upper-lower direction) of the insulating layer 32 of the flat electric wire 30.

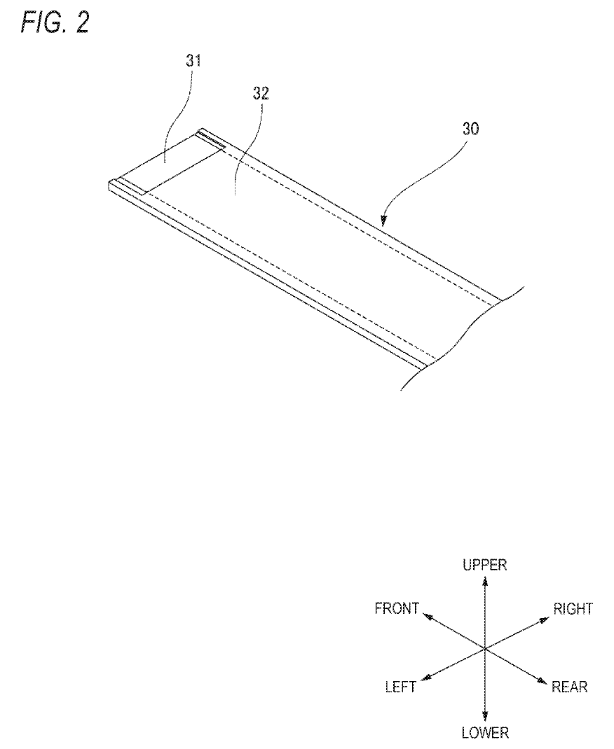

Next, the flat electric wire 30 will be described. As illustrated in FIGS. 2, 3, and the like, the flat electric wire 30 has a long flat shape that is flat and short in the upper-lower direction and extends in the front-rear direction, and has flexibility that allows the flat electric wire 30 to be routed so as to extend in the front-rear direction while being flexibly curved (bent) in the upper-lower direction. The flat electric wire 30 includes the sheet-like conductor layer 31 and the insulating layer 32 covering an outer periphery of the conductor layer 31. As illustrated in FIG. 2, at the end portion (front end portion) of the flat electric wire 30, the insulating layer 32 covering the upper side and the lower side of the conductor layer 31 is removed by so-called terminal processing, and the upper and lower surfaces of the conductor layer 31 are exposed. The members constituting the connector 1 are described above.

Next, an assembling procedure of the connector 1 will be described. In order to assemble the connector 1, first, as illustrated in FIG. 3, the terminal 20 is accommodated in the accommodating portion 11 of the housing 10. Specifically, the terminal 20 is inserted into the accommodating portion 11 of the housing 10 from the rear side until the extending end portion (rear end portion) of the wall-shaped portion 22 of the terminal 20 is locked to the protrusion 13 of the housing 10. In the process of inserting the terminal 20, each of the upper and lower walls of the housing 10 is elastically deformed outward in the upper-lower direction by being pushed away (pressed) from the terminal 20 until the extending end portion of the wall-shaped portion 22 of the terminal 20 overcomes the protrusion 13, but is elastically restored inward in the upper-lower direction once the extending end portion of the wall-shaped portion 22 of the terminal 20 overcomes the protrusion 13. As a result, the extending end portion of the wall-shaped portion 22 of the terminal 20 is locked to the protrusion 13.

In a state in which the terminal 20 is completely accommodated in the accommodating portion 11 of the housing 10, as illustrated in FIG. 3, the displacement of the terminal 20 in the rearward direction in which the terminal 20 comes out of the housing 10 is restricted by the engagement between the extending end portion of the wall-shaped portion 22 of the terminal 20 and the protrusion 13. Accordingly, unintentional separation of the terminal 20 from the housing 10 is prevented. Further, the front end surface of the terminal 20 (the front end surface of the main body portion 21) is in contact with a bottom wall 11b defining the front end surface of the accommodating portion 11 of the housing 10. Accordingly, further forward relative movement of the terminal 20 with respect to the housing 10 is prevented. The outer surface of the wall-shaped portion 22 of the terminal 20 is disposed to face the inner surface 11a of the accommodating portion 11 of the housing 10, and the pair of upper and lower wall-shaped portions 22 of the terminal 20 are maintained in the non-elastically deformed state.

Next, as indicated by white arrows in FIGS. 3 and 4, the end portion of the flat electric wire 30 is inserted into the space S between the pair of upper and lower wall-shaped portions 22 of the terminal 20 from the rear side. The operation of inserting the flat electric wire 30 may be performed manually by an operator, or may be performed using an arm or the like of an automatic assembly apparatus (not illustrated). In an insertion completion state of the flat electric wire 30, as illustrated in FIGS. 4 and 5, the tip of the exposed conductor layer 31 of the flat electric wire 30 is in contact with the rear end surface of the main body portion 21 of the terminal 20. The exposed conductor layer 31 of the flat electric wire 30 is pressed and sandwiched by (in pressure contact with) the pair of upper and lower contact portions 25 of the terminal 20, and the end portion of the insulating layer 32 of the flat electric wire 30 is pressed and sandwiched by (in pressure contact with) the pair of upper and lower engaging protrusions 26 of the terminal 20. The tip portions of the pair of upper and lower engaging protrusions 26 bite into the end portion of the insulating layer 32 of the flat electric wire 30 (see FIG. 5). The pair of upper and lower wall-shaped portions 22 of the terminal 20 receive forces in directions away from each other (outward in the upper-lower direction) from the contact portions 25 and the engaging protrusions 26 that are in pressure contact with the conductor layer 31 and the insulating layer 32 of the flat electric wire 30, respectively, and thus tend to elastically deform outward in the upper-lower direction. However, the pair of upper and lower wall-shaped portions 22 of the terminal 20 are maintained in the non-elastically deformed state by being in pressure contact with the inner surfaces 11a of the accommodating portion 11 of the housing 10 disposed to face the outer surfaces of the pair of upper and lower wall-shaped portions 22 and receiving reaction forces in directions approaching each other (inward in the upper-lower direction) from the inner surfaces 11a.

As described above, the assembly of the connector 1 is completed, and the connector 1 illustrated in FIGS. 1, 4, and 5 is obtained. In the assembled state of the connector 1, the exposed conductor layer 31 of the flat electric wire 30 is pressed and sandwiched by the pair of upper and lower contact portions 25 of the terminal 20, so that the flat electric wire 30 is electrically connected to the terminal 20. Further, the pair of upper and lower engaging protrusions 26 of the terminal 20 are engaged (in pressure contact) with the end portion of the insulating layer 32 of the flat electric wire 30. Accordingly, as compared with a case in which the contact portion 25 is simply provided in the terminal 20, the displacement of the flat electric wire 30 (for example, displacement such that the flat electric wire 30 is unintentionally separated from the housing 10) is restricted by the action of the engaging protrusion 26. Further, the pair of upper and lower engaging protrusions 26 of the terminal 20 bite into the end portion of the insulating layer 32 of the flat electric wire 30. Accordingly, the engagement between the engaging protrusion 26 and the insulating layer 32 is reinforced as compared with a case in which the engaging protrusion 26 simply comes into pressure contact with the insulating layer 32.

As described above, according to the connector 1 according to the first embodiment, the terminal 20 includes the wall-shaped portion 22 facing the inner surface 11a of the accommodating portion 11 of the housing 10, the contact portion 25 provided on the inner surface of the wall-shaped portion 22 and configured to come into pressure contact with the conductor (conductor layer 31), and the engaging portion (engaging protrusion 26) configured to engage with the insulating layer 32. Accordingly, as compared with a case in which the contact portion 25 is simply provided in the terminal 20, the displacement of the flat electric wire 30 (for example, displacement such that the flat electric wire 30 is unintentionally separated from the housing 10) is restricted by the action of the engaging protrusion 26. Therefore, the connector 1 according to the present embodiment is excellent in reliability of electrical connection between the flat electric wire 30 and the terminal 20.

Further, according to the connector 1 of the first embodiment, the engaging protrusion 26 of the terminal 20 is inserted into the insulating layer 32 to restrict the displacement of the flat electric wire 30 in the direction in which the flat electric wire 30 comes out of the housing 10. Accordingly, for example, the engagement between the engaging protrusion 26 and the insulating layer 32 is reinforced as compared with a case in which the engaging protrusion 26 simply comes into contact with the insulating layer 32. Accordingly, the reliability of the electrical connection between the flat electric wire 30 and the terminal 20 can be further improved.

Further, according to the connector 1 of the first embodiment, the housing 10 includes the protrusion 13 protruding toward the terminal 20. Then, the protrusion 13 comes into contact with the terminal 20 to restrict displacement of the terminal 20 in a direction in which the terminal 20 comes out of the housing 10. Accordingly, unintentional separation of the terminal 20 from the housing 10 is prevented.

Further, according to the connector 1 of the first embodiment, the contact portion 25 of the terminal 20 has a beam shape protruding toward the conductor layer 31 of the flat electric wire 30. Therefore, even when an external force such as vibration is applied to the connector 1 during use of the connector 1, the contact portion 25 is elastically deformed to absorb the external force so as to appropriately maintain a state in which the contact portion 25 and the conductor 31 are in pressure contact with each other. Accordingly, the reliability of the electrical connection between the flat electric wire 30 and the terminal 20 can be further improved.

### Second Embodiment

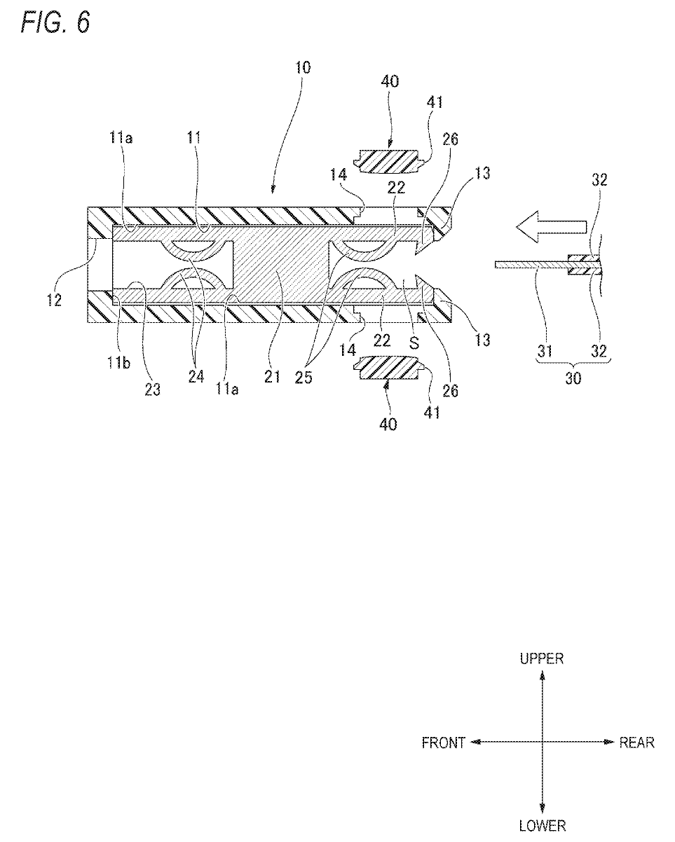

Hereinafter, the connector 1 according to a second embodiment of the present disclosure will be described with reference to FIGS. 6-9. The second embodiment is different from the first embodiment in that the first embodiment is not provided with a configuration in which an opening portion 14 is provided in each of portions of the upper wall and the lower wall of the housing 10 disposed to face the wall-shaped portion 22 of the terminal 20, and a pressing member 40 is assembled to the housing 10 so as to close each of the pair of upper and lower opening portions 14. The pressing member 40 is a resin molded body and is a flat plate-shaped member having an outer peripheral shape corresponding to the opening shape of the opening portion 14. In the example illustrated in FIG. 6, the pressing member 40 is a member separate from the housing 10, but may be connected to the housing 10 by a hinge portion.

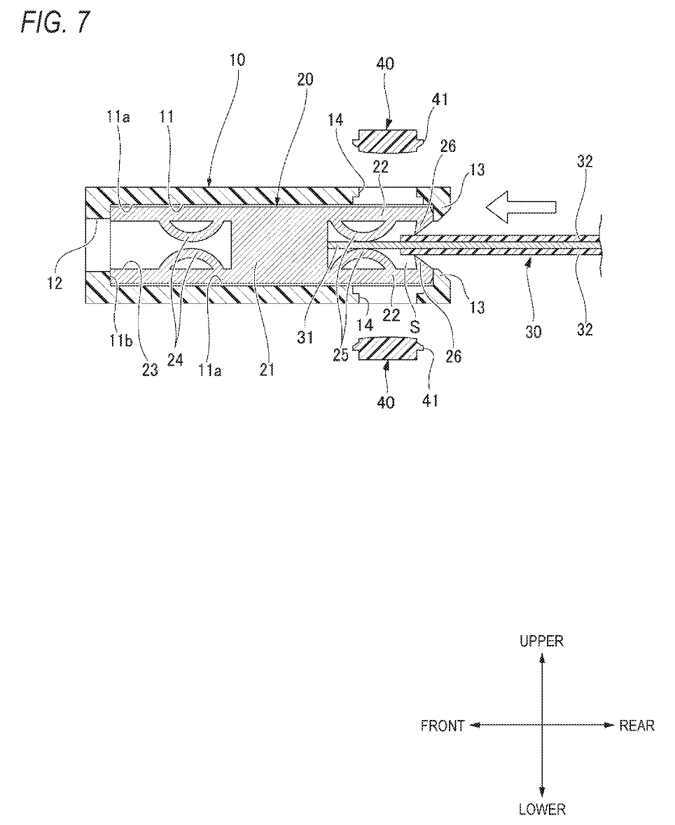

In order to assemble the connector 1 according to the second embodiment, the terminal 20 is first accommodated in the accommodating portion 11 of the housing 10 as illustrated in FIG. 6 from a state in which the pressing member 40 is not assembled to the housing 10. Next, as indicated by white arrows in FIGS. 6 and 7, an end portion of the flat electric wire 30 is inserted into the space S between the pair of upper and lower wall-shaped portions 22 of the terminal 20 from a rear side. Since a procedure of housing the terminal 20 in the accommodating portion 11 and a procedure of inserting the flat electric wire 30 into the space S are the same as those in the first embodiment, detailed description thereof will be omitted here. In the example illustrated in FIG. 7, in the insertion completion state of the flat electric wire 30, the exposed conductor layer 31 of the flat electric wire 30 is sandwiched between (in contact with) the pair of upper and lower contact portions 25 of the terminal 20, and the end portion of the insulating layer 32 of the flat electric wire 30 is sandwiched between (in contact with) the pair of upper and lower engaging protrusions 26 of the terminal 20. Accordingly, the flat electric wire 30 can be positioned with respect to the terminal 20. However, at this stage, the exposed conductor layer 31 of the flat electric wire 30 may not be sandwiched between (in contact with) the pair of upper and lower contact portions 25 of the terminal 20, and the end portion of the insulating layer 32 of the flat electric wire 30 may not be sandwiched between (in contact with) the pair of upper and lower engaging protrusions 26 of the terminal 20.

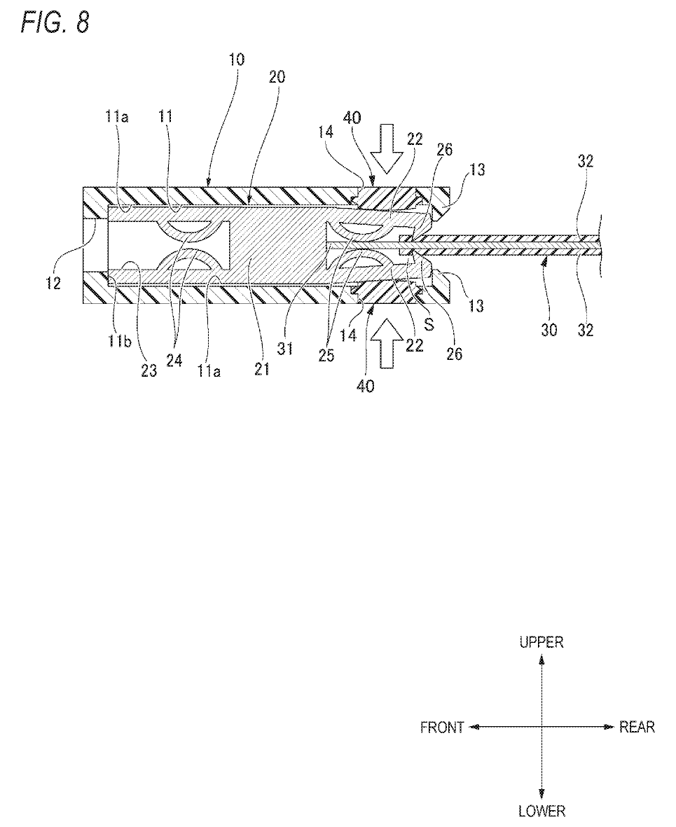

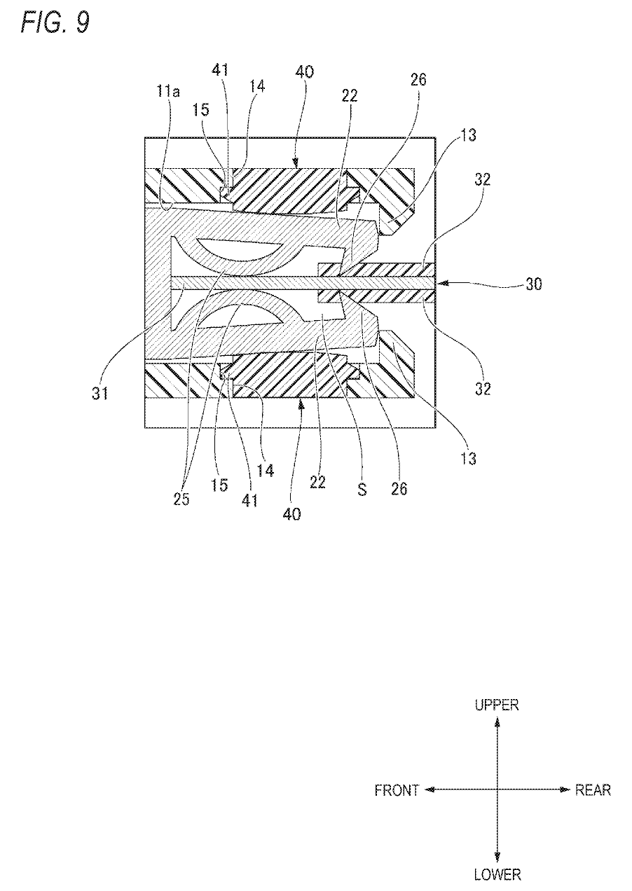

Next, as indicated by white arrows in FIG. 8, the pair of upper and lower pressing members 40 are assembled to the housing 10 so as to close the pair of upper and lower opening portions 14, respectively. In a state in which the pressing member 40 is completely assembled to the housing 10, a locking protrusion 41 provided on an outer peripheral edge portion of the pressing member 40 is locked to a locking groove 15 provided on an opening edge portion of the opening portion 14 (see FIG. 9). Accordingly, the pressing member 40 is prevented from falling off the housing 10. Further, the inner surface of the pressing member 40 (the surface facing the wall-shaped portion 22 of the terminal 20) is positioned further inward of the accommodating portion 11 (inward in an upper-lower direction) with respect to the inner surface 11a of the accommodating portion 11 of the housing 10. As described above, since the inner surface of the pressing member 40 is positioned further inward of the accommodating portion 11 (inward in the upper-lower direction) with respect to the inner surface 11a, the pair of upper and lower wall-shaped portions 22 of the terminal 20 are maintained in a state of being displaced by elastic deformation inward in the upper-lower direction (toward the flat electric wire 30) due to displacement (pressing) from the inner surface of the pressing member 40 as indicated by white arrows in FIG. 8.

Since the pair of upper and lower wall-shaped portions 22 are maintained in the displaced state in this way, as illustrated in FIG. 9, the exposed conductor layer 31 of the flat electric wire 30 is pressed and sandwiched by (in pressure contact with) the pair of upper and lower contact portions 25 of the terminal 20, and the pair of upper and lower engaging protrusions 26 of the terminal 20 are engaged with the end portion of the insulating layer 32 of the flat electric wire 30 so as to bite thereinto while being in pressure contact therewith. As described above, since the pressing member 40 functions to displace the wall-shaped portion 22, the contact between the contact portion 25 of the terminal 20 and the conductor layer 31 of the flat electric wire 30 and the engagement between the engaging protrusion 26 of the terminal 20 and the insulating layer 32 of the flat electric wire 30 are reinforced as the wall-shaped portion 22 of the terminal 20 is displaced. Further, in the example illustrated in FIG. 9, the sharp tip portion of the engaging protrusion 26 of the terminal 20 pierces the end portion of the insulating layer 32 of the flat electric wire 30, and is in contact with the conductor layer 31 covered with the end portion of the insulating layer 32. Such contact between the engaging protrusion 26 of the terminal 20 and the conductor layer 31 of the flat electric wire 30 can further enhance the reliability of the electrical connection between the flat electric wire 30 and the terminal 20.

### Other Embodiments

The present disclosure is not limited to the embodiment described above, and various modifications can be adopted within the scope of the present disclosure. For example, the present disclosure is not limited to the embodiment described above, and modifications, improvements, and the like can be appropriately made. In addition, materials, shapes, sizes, numbers, arrangement positions, and the like of components in the embodiment described above are freely selected and are not limited as long as the present disclosure can be implemented.

For example, in the above embodiments, the contact portion 25 of the terminal 20 has a double-supported beam shape extending in the front-rear direction. However, the contact portion 25 of the terminal 20 may have a cantilever beam shape extending in the front-rear direction.

Further, in the above embodiment, the displacement of the terminal 20 in the rearward direction in which the terminal 20 comes out of the housing 10 is restricted by the engagement between the protrusion 13 of the housing 10 protruding toward the terminal 20 (inward in the upper-lower direction) and the terminal 20. Instead of this, the displacement of the terminal 20 in the rearward direction in which the terminal 20 comes out of the housing 10 may be restricted by engagement between a "protrusion" of the terminal 20 protruding toward the housing 10 (outward in the upper-lower direction) and the housing 10.

Further, in the above embodiment, the flat electric wire 30 includes one conductor layer 31. With respect to this, the flat electric wire 30 may include a plurality of conductor layers 31 arranged in a width direction or a thickness direction.

Further, in the above embodiment, the contact portions 25 are in contact with the upper and lower surfaces of the conductor layer 31 exposed at the end portion of the flat electric wire 30. With respect to this, a reinforcing layer (for example, a layer in which the insulating layer 32 above or below the conductor layer 31 is left without being removed, a plate material attached to the upper surface or the lower surface of the flat electric wire 30, a dummy conductor layer that is not used as a circuit when the flat electric wire 30 has a multilayer structure, or the like) may be provided above or below the conductor layer 31. Accordingly, for example, the step of inserting the end portion of the flat electric wire 30 into the terminal 20 (see FIGS. 3 and 4) can be easily performed.

Here, the features of the embodiments of the connector 1 and the housing unit 2 according to the present disclosure described above will be briefly summarized and listed in the following [1] to [6].

1. A connector (1) including:
a housing (10);
a terminal (20) that is accommodated in the housing (10); and
a flat electric wire (30) that is electrically connected to the terminal (20), in which the flat electric wire (30) includes
a conductor (31), and
an insulating layer (32) sandwiching the conductor (31), and the terminal (20) includes
a wall-shaped portion (22) defining a space (S) in which the conductor (31) of the flat electric wire (30) is disposed and facing an inner surface (11a) of an accommodating portion (11) of the housing (10),
a contact portion (25) provided on an inner surface of the wall-shaped portion (22) and coming into pressure contact with the conductor (31), and
an engaging portion (26) engaging with the insulating layer (32).

According to the connector having the above configuration [1], the terminal includes the wall-shaped portion facing the inner surface of the accommodating portion of the housing, the contact portion provided on the inner surface of the wall-shaped portion and configured to come into pressure contact with the conductor, and the engaging portion configured to engage with the insulating layer. Accordingly, as compared with a case in which the contact portion is simply provided in the terminal, the displacement of the flat electric wire (for example, displacement such that the flat electric wire is unintentionally separated from the housing) is restricted by the action of the engaging portion. Therefore, the connector having this configuration is excellent in reliability of electrical connection between the flat electric wire and the terminal.

2. The connector (1) according to the above [1], in which
the engaging portion (26) of the terminal (20) has a shape protruding toward the flat electric wire (30) and is inserted into the insulating layer (32) to restrict displacement of the flat electric wire (30) in a direction in which the flat electric wire (30) comes out of the housing (10).

According to the connector having the above configuration [2], the engaging portion of the terminal is inserted into the insulating layer to restrict the displacement of the flat electric wire in the direction in which the flat electric wire comes out of the housing. Accordingly, for example, the engagement between the engaging portion and the insulating layer is reinforced as compared with a case in which the engaging portion simply comes into contact with the insulating layer. Accordingly, the reliability of the electrical connection between the flat electric wire and the terminal can be further improved.

3. The connector (1) according to the above [1], in which
one of the housing (10) and the terminal (20) has a protrusion (13) protruding toward the other of the housing (10) and the terminal (20), and
the connector (1) restricts displacement of the terminal (20) in a direction in which the terminal (20) comes out of the housing (10) by the protrusion (13) coming into contact with the other of the housing and the terminal.

According to the connector having the above configuration [3], one of the housing and the terminal includes the protrusion protruding toward the other of the housing and the terminal. Then, the protrusion comes into contact with the other to restrict displacement of the terminal in a direction in which the terminal comes out of the housing. Accordingly, unintentional separation of the terminal from the housing is prevented.

4. The connector (1) according to the above [1], in which
the contact portion (25) of the terminal (20) has a beam shape protruding toward the conductor (31) of the flat electric wire (30).

According to the connector having the above configuration [4], the contact portion of the terminal has a beam shape protruding toward the conductor of the flat electric wire. Therefore, even when an external force such as vibration is applied to the connector during use of the connector, the contact portion is elastically deformed to absorb the external force so as to appropriately maintain a state in which the contact portion and the conductor are in pressure contact with each other. Accordingly, the reliability of the electrical connection between the flat electric wire and the terminal can be further improved.

5. The connector (1) according to the above [1], further including:
an accessory component (40) that is assembled to the housing (10), in which
the accessory component (40) comes into contact with the wall-shaped portion (22) so that the wall-shaped portion (22) is displaced so as to approach the flat electric wire (30), whereby the contact portion (25) comes into pressure contact with the conductor (31), and the engaging portion (26) engages with the insulating layer (32).

According to the connector having the above configuration [5], the accessory component assembled to the housing comes into contact with the wall-shaped portion to cause the wall-shaped portion to be displaced so as to approach the flat electric wire, whereby the contact portion comes into pressure contact with the conductor, and the engaging portion engages with the insulating layer. Accordingly, the contact between the contact portion and the conductor and the engagement between the engaging portion and the insulating layer are reinforced as the wall-shaped portion of the terminal is displaced. Accordingly, the reliability of the electrical connection between the flat electric wire and the terminal can be further improved.

6. A housing unit (2) to be attached to an end portion of a flat electric wire (30), the housing unit (2) including:
a housing (10); and
a terminal (20) that is accommodated in the housing (10), in which the terminal (20) includes
a wall-shaped portion (22) defining a space (S) in which a conductor (31) of the flat electric wire (30) is disposed and facing an inner surface (11a) of an accommodating portion (11) of the housing (10),
a contact portion (25) provided on an inner surface of the wall-shaped portion (22) and coming into pressure contact with the conductor (31), and
an engaging portion (26) engaging with an insulating layer (32) of the flat electric wire (30).

According to the housing unit having the above configuration [6], the terminal includes the wall-shaped portion facing the inner surface of the accommodating portion of the housing, the contact portion provided on the inner surface of the wall-shaped portion and configured to come into pressure contact with the conductor, and the engaging portion configured to engage with the insulating layer. Accordingly, as compared with a case in which the contact portion is simply provided in the terminal, the displacement of the flat electric wire (for example, displacement such that the flat electric wire is unintentionally separated from the housing) is restricted by the action of the engaging portion. Therefore, the housing unit having this configuration is excellent in reliability of electrical connection between the flat electric wire and the terminal.

What is claimed is:

1. A connector comprising:
a housing;
a terminal that is accommodated in the housing; and
a flat electric wire that is electrically connected to the terminal, wherein the flat electric wire includes
a conductor, and
an insulating layer sandwiching the conductor, and
the terminal includes
a wall-shaped portion defining a space in which the conductor of the flat electric wire is disposed and facing an inner surface of an accommodating portion of the housing,
a contact portion provided on an inner surface of the wall-shaped portion and coming into pressure contact with the conductor, and
an engaging portion engaging with the insulating layer.

2. The connector according to claim 1, wherein
the engaging portion of the terminal has a shape protruding toward the flat electric wire and is inserted into the insulating layer to restrict displacement of the flat electric wire in a direction in which the flat electric wire comes out of the housing.

3. The connector according to claim 1, wherein
one of the housing and the terminal has a protrusion protruding toward the other of the housing and the terminal, and
the connector restricts displacement of the terminal in a direction in which theterminal comes out of the housing by the protrusion coming into contact with the other of thehousing and the terminal.

4. The connector according to claim 1, wherein
the contact portion of the terminal has a beam shape protruding toward the conductor of the flat electric wire.

5. The connector according to claim 1, further comprising:
an accessory component that is assembled to the housing, wherein
the accessory component comes into contact with the wall-shaped portion so that the wall-shaped portion is displaced so as to approach the flat electric wire, whereby the contact portion comes into pressure contact with the conductor, and the engaging portion engages with the insulating layer.

6. A housing unit attached to an end portion of a flat electric wire, the housing unit comprising:
a housing; and
a terminal that is accommodated in the housing, wherein the terminal includes
a wall-shaped portion defining a space in which a conductor of the flat electric wire is disposed and facing an inner surface of an accommodating portion the
housing,
a contact portion provided on an inner surface of the wall-shaped portion and coming into pressure contact with the conductor, and
an engaging portion engaging with an insulating layer of the flat electric wire.
